(19) United States
(12) Patent Application Publication
(10) Pub. No.: US 2022/0322380 A1
(43) Pub. Date: Oct. 6, 2022

(54) Enhanced Sidelink Channel Cellular Coverage

(71) Applicant: Apple Inc., Cupertino, CA (US)

(72) Inventors: Chunxuan Ye, San Diego, CA (US); Dawei Zhang, Saratoga, CA (US); Haijing Hu, Beijing (CN); Haitong Sun, Irvine, CA (US); Hong He, Cupertino, CA (US); Jie Cui, San Jose, CA (US); Wei Zeng, San Diego, CA (US); Yushu Zhang, Beijing (CN); Zhibin Wu, Los Altos, CA (US)

(21) Appl. No.: 17/438,512

(22) PCT Filed: Oct. 29, 2020
(86) PCT No.: PCT/CN2020/124799

§ 371 Date: Sep. 13, 2021

(51) Int. Cl. H04W 72/12; H04L 5/00

(52) U.S. Cl. CPC H04W 72/1263; H04L 5/0094; H04W 72/1278; H04W 92/18

(57) ABSTRACT

Embodiments are presented herein of apparatuses, systems, and methods for a user equipment (UE) to establish communication over a sidelink channel with a second UE over a New Radio (NR) physical sidelink shared channel (PSSCH). Embodiments described herein provide coverage enhancement for NR PSSCH in the areas of narrowband transmission with frequency hopping, support for PSSCH repetition and advanced PSSCH repetition.

### FIELD

The present application relates to wireless networks for user equipment (UE) devices, and more particularly to a system and method for providing coverage enhancement for a sidelink channel, such as the Physical Sidelink Shared Channel (PSSCH).

### DESCRIPTION OF THE RELATED ART

Wireless communication systems are rapidly growing in usage. One proposed use of wireless communications is in vehicular applications, particularly in V2X (vehicle-to-everything) systems. V2X systems allow for communication between vehicles (e.g., via communications devices housed in or otherwise carried by vehicles), pedestrian UEs (including UEs carried by other persons such as cyclists, etc.), and other wireless communications devices for various purposes, such as to coordinate traffic activity, facilitate autonomous driving, and perform collision avoidance.

The increased demand for V2X communication has increased the need for reliable, long-range wireless coverage for sidelink transmission, by which a UE may communicate directly with another UE. Accordingly, improvements in the field would be desirable.

### SUMMARY OF THE INVENTION

Embodiments are presented herein of apparatuses, systems, and methods for a user equipment (UE) to establish communication with a second UE over a sidelink channel, such as the physical sidelink shared channel (PSSCH). Embodiments described herein may provide coverage enhancement for the sidelink channel, e.g., the NR PSSCH, in the areas of narrowband transmission with frequency hopping, support for PSSCH repetition and advanced PSSCH repetition.

Some embodiments relate to a user equipment (UE), comprising at least one antenna, a radio operably coupled to the at least one antenna, and a processor operably coupled to the radio. The UE may transmit data over the PSSCH to a second UE. The data may be transmitted over a narrowband frequency domain sub-channel of the PSSCH using one or more physical resource blocks (PRBs). The number of PRBs may correspond to the narrowband bandwidth, and in some embodiments, may comprise one PRB.

In some embodiments, the PSSCH comprises a plurality of sub-channels, and each sub-channel comprises a plurality of PRBs. The UE may then be configured to transmit on a narrowband subset of the plurality of PRBs.

The UE may transmit data over the PSSCH in accordance with a frequency hopping pattern. For example, the UE may first define a resource unit (RU) as one or more of a number of PRBs or a number of subchannels in the frequency domain and a number of symbols in the time domain. The UE may then define a frequency hopping pattern over the PSSCH as comprising a plurality of predetermined RUs. Each predetermined RU may be located at one or more of a different time or a different frequency based on the frequency hopping pattern. The UE may then transmit the data using the predetermined RUs in accordance with the frequency hopping pattern. An example of a frequency hopping pattern is: n(i)=(s+i×P) mod N, where n(i) is a frequency location of the (i +1)th hopping, s is a starting frequency unit, P is a hopping distance and N is a total number of frequency resource units.

The frequency hopping pattern may be configured differently for each sidelink resource pool P. Frequency hopping may also be designed to allow a resource unit to cross a resource pool boundary.

During the performance of frequency hopping a UE may determine, through resource sensing, that an RU is unavailable. In response to determining that an RU in the frequency hopping pattern is unavailable, the UE may perform one of various procedures. For example, when a frequency hopping pattern collides with an unavailable RU, the UE may omit the corresponding hopping location. As another example, when a frequency hopping pattern collides with an unavailable RU, the UE may shift the corresponding hopping occasion to the next available RU. As another example, the RU that has been selected as available through resource sensing may be indexed in increasing order. for example, frequency domain first and time domain second. The UE may then perform frequency hopping based on the index of the selected RU. In some embodiments, a UE may be given priority of selection of RUs in a resource pool, such that the UE need not perform sensing, only perform partial sensing or random selection. In such a case, the UE may not take any action in response to determining a potentially unavailable RU.

Embodiments described herein support flexible PSSCH repetition in order to provide coverage enhancement. PSSCH repetition may be adopted through one or more of the following steps. Step 1: A Super Resource Unit (SRU) may be defined for PSSCH, and each SRU may contain multiple symbols or slots. Step 2: Each repetition may be configured to contain multiple SRUs. Step 3: The number of repetitions may be dynamically indicated by sidelink control information (SCI). The configuration of the SRU and the repetitions may be achieved through hardcoding in the specification or via radio resource control (RRC) or medium access control-control element (MAC-CE).

Some embodiments relate to a baseband processor having processing circuitry configured to perform at least a portion or all of the above operations.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example vehicle-to-everything (V2X) communication system, according to some embodiments;

FIG. 2 illustrates a base station in communication with a user equipment (UE) device, according to some embodiments;

FIG. 3 is an example block diagram of a UE, according to some embodiments;

FIG. 4 is an example block diagram of a base station, according to some embodiments;

FIG. 5 illustrates an example of a vehicle-to-everything network, according to some embodiments;

FIG. 6 illustrates an existing New Radio (NR) sidelink resource block (RB) allocation;

FIG. 7 illustrates an example New Radio (NR) sidelink resource block (RB) allocation over narrow band, according to some embodiments;

FIG. 8 is a flowchart diagram illustrating an example method for a UE to perform enhanced coverage for sidelink narrowband transmission, according to some embodiments;

FIG. 9 is a flowchart diagram illustrating an example method for a UE to perform PSSCH transmission repetition, according to some embodiments.

FIG. 10 illustrates an example of narrow band transmission with frequency hopping, according to some embodiments;

FIG. 11 illustrates an example of flexible PSSCH repetition, according to some embodiments;

FIG. 12 illustrates an example of flexible PSSCH repetition using a beam-based system, according to some embodiments;

FIG. 13 illustrates three examples of advanced PSSCH repetition, according to some embodiments; and

FIG. 14 illustrates management of interruption of repetition occasions, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

Various acronyms are used throughout the present disclosure. Definitions of the most prominently used acronyms that may appear throughout the present disclosure are provided below:
UE: User Equipment
RF: Radio Frequency
BS: Base Station
NW: Network
DL: Downlink
UL: Uplink
BW: Bandwidth
GSM: Global System for Mobile Communication
UMTS: Universal Mobile Telecommunication System
LTE: Long Term Evolution
NR: New Radio
NR-U: NR Unlicensed
TX: Transmission/Transmit
RX: Reception/Receive
RAT: Radio Access Technology
RAN: Radio Access Network
DCI: Downlink Control Information
V2X: Vehicle to Everything
PSCCH: Physical Sidelink Control Channel
PSSCH: Physical Sidelink Shared Channel
PUCCH: Physical Uplink Control Channel
PUSCII: Physical Uplink Shared Channel
PDCCH: Physical Downlink Control Channel
RRC: Radio Resource Control
SCI: Sidelink Control Information
AGC: Automatic Gain Control
CSI: Channel Status Information
RB: Resource Block
PRB: Physical Resource Block
RU: Resource Unit
SRU: Super Resource Unit
SCS: Subcarrier Spacing
MAC-CE: Medium Access Control-Control Element
HARQ: Hybrid automatic repeat request
Uu Interface: Air interface linking User Equipment (UE) to Universal Mobile Telecommunications System Terrestrial Radio Access Network
dB: Decibel
MCL: Maximum coupling loss
ISM: Industrial, Scientific and Medical
FR2: Frequency Range 2—corresponding to 24250 MHz-52600 MHz
TB: Transport Block
RV: Redundancy Version
DMRS: Demodulation Reference Signal
QCL: Quasi-Colocation
NLOS: Non-Line of Sight
RSRP: Reference Signal Received Power
OFDM: Orthogonal Frequency Division Multiplexing
The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, unmanned aerial vehicles (UAVs), unmanned aerial controllers (UACs), vehicles, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Infrastructure Device—as used herein, may refer generally in the context of V2X systems to certain devices in a V2X system that are not user devices, and are not carried by traffic actors (i.e., pedestrians, vehicles, or other mobile users), but rather that facilitate user devices' participation in the V2X network. Infrastructure devices include base stations and roadside units (RSUs).

User Device—as used herein, may refer generally in the context of V2X systems to devices that are associated with mobile actors or traffic participants in a V2X system, i.e., mobile (able-to-move) communication devices such as vehicles and pedestrian user equipment (PUE) devices, as opposed to infrastructure devices, such as base stations, roadside units (RSUs), and servers.

Pedestrian UE (PUE) Device—a user equipment (UE) device that may be worn or carried by various persons, including not only pedestrians in the strict sense of persons walking near roads, but also certain other peripheral or minor participants, or potential participants, in a traffic environment. These include stationary persons, persons not on vehicles who may not necessarily be near traffic or roads, persons jogging, running, skating, and so on, or persons on vehicles that may not substantially bolster the UE's power capabilities, such as bicycles, scooters, or certain motor vehicles. Examples of pedestrian UEs include smart phones, wearable UEs, PDAs, etc.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the tem “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Sidelink—in cellular communications, a sidelink is a transmission path from a User Equipment (UE) directly to another User Equipment (UE).

Contention—is a condition that occurs when two or more mobile devices or UEs are contending for the same network resources.

Maximum Coupling Loss (MCL)—Maximum Coupling Loss is a metric to evaluate coverage of a radio access technology. In theory, it can be defined as the maximum loss in the conducted power level that a system can tolerate and still be operational.

Resource element (RE)—An RE is composed of a subcarrier over an OFDM symbol.

Resource block (RB) An RB is composed of 12 consecutive subcarriers with the same SCS, and thus the bandwidth of an RB depends on the SCS value of subcarriers.

Resource grid—A resource grid is composed of a number of RBs with the same SCS.

Resource pool—A resource pool is a set of resources assigned to the sidelink operation. It consists of the subframes and the resource blocks within.

Device Pair (Or UE Pair)—A pair of UEs in communication with one another.

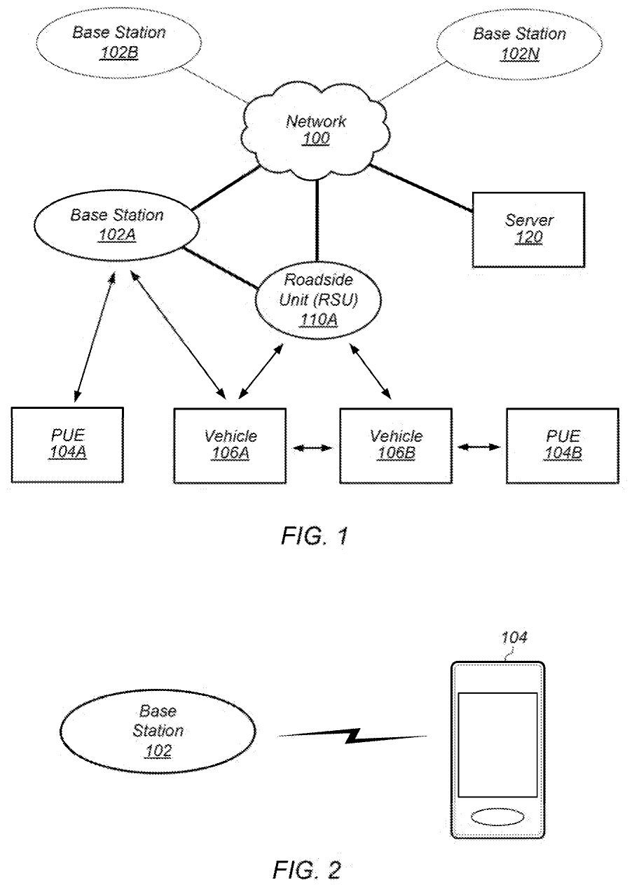

### FIG. 1—V2X Communication System

FIG. 1 illustrates one example of a cellular communication system which may employ sidelink communications. As one specific example, FIG. 1 illustrates an example vehicle-to-everything (V2X) communication system, according to some embodiments. It is noted that the system of FIG. 1 is merely one example of a possible system, and that features of this disclosure may be implemented in any of various systems, as desired.

Vehicle-to-everything (V2X) communication systems may be characterized as networks in which vehicles, UEs, and/or other devices and network entities exchange communications in order to coordinate traffic activity, among other possible purposes. V2X communications include communications conveyed between a vehicle (e.g., a wireless device or communication device constituting part of the vehicle, or contained in or otherwise carried along by the vehicle) and various other devices. V2X communications include vehicle-to-pedestrian (V2P), vehicle-to-infrastructure (V2I), vehicle-to-network (V2N), and vehicle-to-vehicle (V2V) communications, as well as communications between vehicles and other possible network entities or devices. V2X communications may also refer to communications between other non-vehicle devices participating in a V2X network for the purpose of sharing V2X-related information.

V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short- to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs. Certain LTE standards usable in V2X systems may be called LTE-Vehicle (LTE-V) standards.

As shown, the example V2X system includes a number of user devices. As used herein in the context of V2X systems, and as defined above, the term “user devices” may refer generally to devices that are associated with mobile actors or traffic participants in the V2X system, i.e., mobile (able-to-move) communication devices such as vehicles and pedestrian user equipment (PUE) devices. User devices in the example V2X system include the PUEs 104A and 104B and the vehicles 106A and 106B.

The vehicles 106 may constitute various types of vehicles. For example, the vehicle 106A may be a road vehicle or automobile, a mass transit vehicle, or another type of vehicle. The vehicles 106 may conduct wireless communications by various means. For example, the vehicle 106A may include communications equipment as part of the vehicle or housed in the vehicle, or may communicate through a wireless communications device currently contained within or otherwise carried along by the vehicle, such as a user equipment (UE) device (e.g., a smartphone or similar device) carried or worn by a driver, passenger, or other person on board the vehicle, among other possibilities. For simplicity, the term “vehicle” as used herein may include the wireless communications equipment which represents the vehicle and conducts its communications. Thus, for example, when the vehicle 106A is said to conduct wireless communications, it is understood that, more specifically, certain wireless communications equipment associated with and carried along by the vehicle 106A is performing the wireless communications.

The pedestrian UEs (PUEs) 104 may constitute various types of user equipment (UE) devices, i.e., portable devices capable of wireless communication, such as smartphones, smartwatches, etc., and may be associated with various types of users. Thus, the PUEs 104 are UEs, and may be referred to as UEs or UE devices. Note that although the UEs 104 may be referred to as PUEs (pedestrian UEs), they may not necessarily be carried by persons who are actively walking near roads or streets. PUEs may refer to UEs participating in a V2X system that are carried by stationary persons, by persons walking or running, or by persons on vehicles that may not substantially bolster the devices' power capabilities, such as bicycles, scooters, or certain motor vehicles. Note also that not all UEs participating in a V2X system are necessarily PUEs.

The user devices may be capable of communicating using multiple wireless communication standards. For example, the UE 104A may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS, LTE, LTE-A, LTE-V, HSPA, 3GPP2 CDMA2000, 5G NR, etc.). The UE 104A may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

As shown, certain user devices may be able to conduct communications with one another directly, i.e., without an intermediary infrastructure device such as base station 102A or RSU 110A. As shown, vehicle 106A may conduct V2X-related communications directly with vehicle 106B. Similarly, the vehicle 106B may conduct V2X-related communications directly with PUE 104B. Such peer-to-peer communications may utilize a “sidelink” interface such as the PC5 interface in the case of some LTE and/or 5G NR embodiments. In some embodiments, the PC5 interface supports direct cellular communication between user devices (e.g., between vehicles 106), while the Uu interface supports cellular communications with infrastructure devices such as base stations. The PC5/Uu interfaces are used only as an example, and PCS as used herein may represent various other possible wireless communications technologies that allow for direct sidelink communications between user devices, while Uu in turn may represent cellular communications conducted between user devices and infrastructure devices, such as base stations. Some user devices in a V2X system, e.g., PUE 104A, may be unable to perform sidelink communications, e.g., because they lack certain hardware necessary to perform such communications.

As shown, the example V2X system includes a number of infrastructure devices in addition to the above-mentioned user devices. As used herein, “infrastructure devices” in the context of V2X systems refers to certain devices in a V2X system which are not user devices, and are not carried by traffic actors (i.e., pedestrians, vehicles, or other mobile users), but rather which facilitate user devices' participation in the V2X network. The infrastructure devices in the example V2X system include base station 102A and roadside unit (RSU) 110A.

The base station (BS) 102A may be a base transceiver station (BTS) or cell site (a “cellular base station”), and may include hardware that enables wireless communication with user devices, e.g., with the user devices 104A and 106A.

The communication area (or coverage area) of the base station may be referred to as a “cell” or “coverage”. The base station 102A and user devices such as PUE 104A may be configured to communicate over the transmission medium using any of various radio access technologies (RATs), also referred to as wireless communication technologies, or telecommunication standards, such as GSM, UMTS, LTE, LTE-Advanced (LTE-A), LTE-Vehicle (LTE-V), HSPA, 3GPP2 CDMA2000, 5G NR, etc. Note that if the base station 102A is implemented in the context of LTE, it may alternately be referred to as an ‘eNodeB’, or eNB whereas if the base station 102A is implemented in the context of 5G NR, it may alternately be referred to as a ‘gNodeB’, or gNB.

As shown, the base station 102A may also be equipped to communicate with a network 100 (e.g., the V2X network, as well as a core network of a cellular service provider, a telecommunication network such as a public switched telephone network (PSTN), and/or the Internet, among various possibilities). Thus, the base station 102A may facilitate communication between user devices and/or between user devices and the network 100. The cellular base station 102A may provide user devices, such as UE 104A, with various telecommunication capabilities, such as voice, SMS and/or data services. In particular, the base station 102A may provide connected user devices, such as UE 104A and vehicle 106A, with access to the V2X network.

Thus, while the base station 102A may act as a “serving cell” for user devices 104A and 106A as illustrated in FIG. 1, the user devices 104B and 106B may also be capable of communicating with the base station 102A. The user devices shown, i.e., user devices 104A, 104B, 106A, and 106B may also be capable of receiving signals from (and may possibly be within communication range of) one or more other cells (which might be provided by base stations 102B-N and/or any other base stations), which may be referred to as “neighboring cells”. Such cells may also be capable of fficilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are of course also possible. 100631 Roadside unit (RSU) 110A constitutes another infrastructure device usable for providing certain user devices with access to the V2X network. RSU 110A may be one of various types of devices, such as a base station, e.g., a transceiver station (BTS) or cell site (a “cellular base station”), or another type of device that includes hardware that enables wireless communication with user devices and facilitates their participation in the V2X network.

RSU 110A may be configured to communicate using one or more wireless networking communication protocols (e.g., Wi-Fi), cellular communication protocols (e.g., LTE, LTE-V, 5G NR etc.), and/or other wireless communication protocols. In some embodiments, RSU 110A may be able to communicate with devices using a “sidelink” technology such as PC5.

RSU 110A may communicate directly with user devices, such as the vehicles 106A and 106B as shown. RSU 110A may also communicate with the base station 102A. In some cases, RSU 110A may provide certain user devices, e.g., vehicle 106B, with access to the base station 102A. While RSU 110A is shown communicating with vehicles 106, it may also (or otherwise) be able to communicate with PUEs 104. Similarly, RSU 110A may not necessarily forward user device communications to the base station 102A. In some embodiments, the RSU 110A and may constitute a base station itself, and/or may forward communications to the server 120.

The server 120 constitutes a network entity of the V2X system, as shown, and may be referred to as a cloud server. Base station 102A and/or RSU 110A may relay certain V2X-related communications between the user devices 104 and 106 and the server 120. The server 120 may be used to process certain information collected from multiple user devices, and may administer V2X communications to the user devices in order to coordinate traffic activity. In various other embodiments of V2X systems, various functions of the cloud server 120 may be performed by an infrastructure device such as the base station 102A or RSU 110A, performed by one or more user devices, and/or not performed at all.

### FIG. 2—Communication Between a UE and Base Station

FIG. 2 illustrates a user equipment (UE) device 104 (e.g., one of the PUEs 104A or in FIG. 1) in communication with a base station 102 (e.g., the base station 102A in FIG. 1), according to some embodiments. The UE 104 may be a device with cellular communication capability such as a mobile phone, a hand-held device, a computer or a tablet, or virtually any type of portable wireless device.

The UE 104 may include a processor that is configured to execute program instructions stored in memory. The UE 104 may perform any of the method embodiments described herein by executing such stored instructions. Alternatively, or in addition, the UE 104 may include a programmable hardware element such as an FPGA (field-programmable gate array) that is configured to perform any of the method embodiments described herein, or any portion of any of the method embodiments described herein.

The UE 104 may include one or more antennas for communicating using one or more wireless communication protocols or technologies. In some embodiments, the UE 104 may be configured to communicate using, for example, CDMA2000 (1×RTT /1×EV-DO/HRPD/eHRPD) LTE, and/or 5G NR using a single shared radio and/or 5G NR or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 104 may share one or more parts of a receive and/or transmit chain between multiple wireless communication technologies, such as those discussed above.

In some embodiments, the UE 104 may include separate transmit and/or receive chains (e.g., including separate antennas and other radio components) for each wireless communication protocol with which it is configured to communicate. As a further possibility, the UE 104 may include one or more radios which are shared between multiple wireless communication protocols, and one or more radios which are used exclusively by a single wireless communication protocol. For example, the UE 104 might include a shared radio for communicating using any of LTE, 5G NR, and/or 1×RTT (or LTE or GSM), and separate radios for communicating using each of Wi-Fi and Bluetooth. Other configurations are also possible.

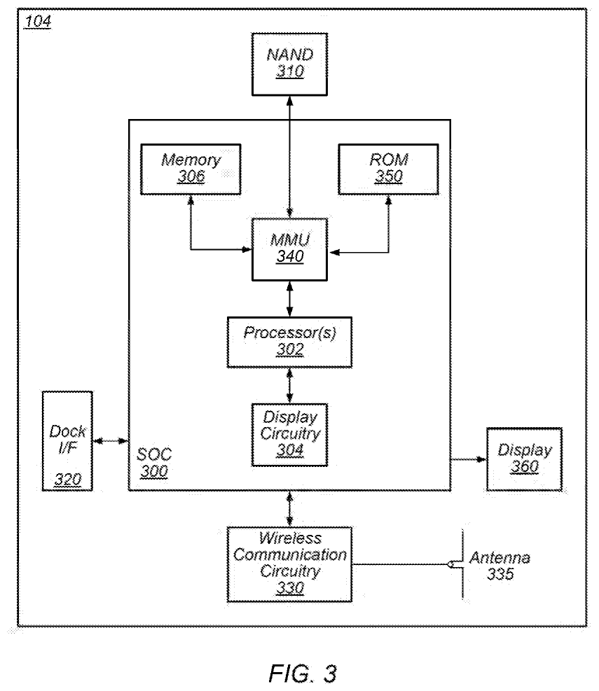

### FIG. 3—UE Block Diagram

FIG. 3 illustrates an example block diagram of a UE 104, according to some embodiments. As shown, the UE 104 may include a system on chip (SOC) 300, which may include portions for various purposes. For example, as shown, the SOC 300 may include processor(s) 302 which may execute program instructions for the UE 104 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector 1/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 104. For example, the UE 104 may include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, LTE-V, 5G NR, CDMA2000, Bluetooth, Wi-Fi, GPS, etc.). The UE may also include at least one SIM device, and may include two SIM devices, each providing a respective international mobile subscriber identity (1MSI) and associated functionality.

As shown, the UE device 104 may include at least one antenna (and possibly multiple antennas, e.g., for MIMO and/or for implementing different wireless communication technologies, among various possibilities) for performing wireless communication with base stations, access points, and/or other devices. For example, the UE device 104 may use antenna 335 to perform the wireless communication.

The UE 104 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

As described herein, the UE 104 may include hardware and software components for implementing features for performing more efficient vehicle-related communication, such as those described herein. The processor 302 of the UE device 104 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition) the processor 302 of the UE device 104, in conjunction with one or more of the other components 300, 304, 306, 310, 320, 330, 335, 340, 350, 360 may be configured to implement part or all of the features described herein, such as the features described herein.

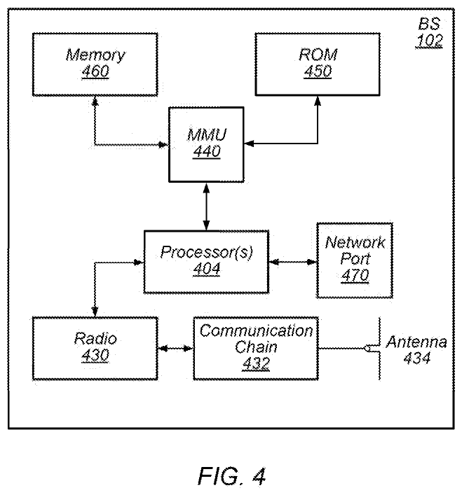

### FIG. 4—Base Station Block Diagram

FIG. 4 illustrates an example block diagram of a base station 102 (e.g., base station 102A in FIG. 1), according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 104, access to the telephone network

The network port 470 (or an additional network port) may also or alternatively be configured to couple to a cellular network, e.g.. a core network of a cellular service provider. The core network may provide mobility related services and/or other services to a plurality of devices, such as UE devices 104. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 104 via radio 430. The antenna 434 communicates with the radio 430 via communication chain 432. Communication chain 432 may be a receive chain, a transmit chain or both. The radio 430 may be configured to communicate via various wireless communication standards, including, but not limited to, LTE, LTE-A, LTE-V, GSM, UMTS, CDMA2000, 5G NR, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another example, the base station 102 may include a 5G NR radio for performing communication according to 5G NR as well as a Wi-Fi radio for performing communication according to Wi-Fi. In such a case, the base station 102 may be capable of operating as both 5G NR base station and a Wi-Fi access point. As a further possibility, the base station 102 may include a multi-mode radio which is capable of performing communications according to any of multiple wireless communication technologies (e.g., LTE and Wi-Fi, LTE and UMTS, LTE and CDMA2000, UMTS and GSM, etc.).

As described further subsequently herein, the BS 102 may include hardware and sollware components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

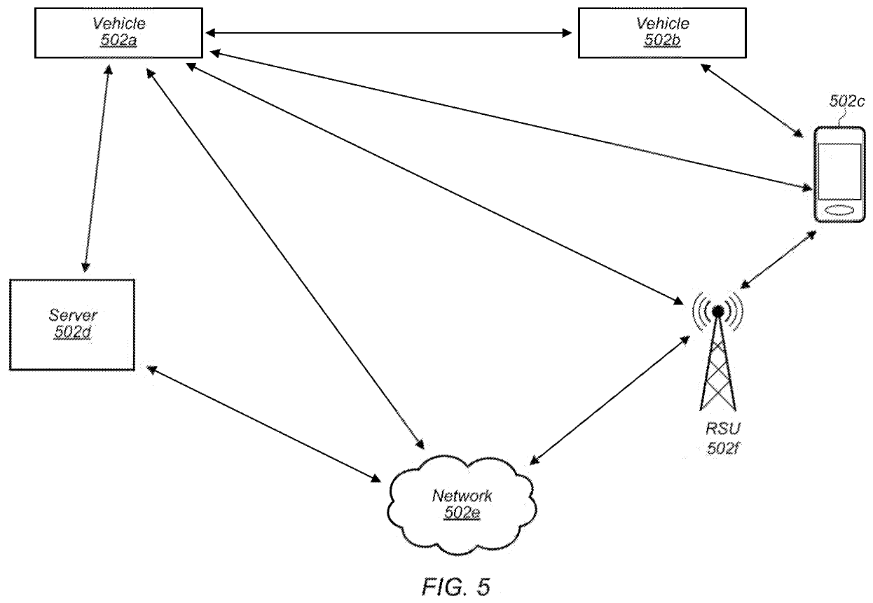

### FIG. 5—Sidelink Resource Management and Coverage

As noted above, certain user devices (or UE devices) may be able to conduct communications with one another directly, i.e., without an intermediary infrastructure device such as base station 102A or RSU 110A. This direct communication between two wireless devices, such as between two vehicles, or between a vehicle UE and a pedestrian UE, is referred to as sidelink communication. Stated another way, two UE devices performing peer-to-peer (direct) communications with each other may each utilize a “sidelink” interface and may be said to be communicating over a sidelink channel.

In some existing implementations, a listen before talk (LBT) mechanism may be used to access the shared medium (e.g., such as unlicensed bands commonly used for Wi-Fi, Bluetooth, and other short to medium range communications, e.g., non-3GGP access) during sidelink communications to avoid collisions (e.g., of transmissions emanating from two or more wireless devices attempting to access the shared medium) and to improve medium utilization efficiency. However, LBT mechanisms are not collision free. In other words, LBT mechanisms cannot guarantee collision free transmissions.

In some implementations, in order to avoid collisions a transmitter may reserve periodic slots within a reservation period for communication. In such implementations, if collisions occur, the collisions could persist for at least a portion of the reservation period (and in a worst-case scenario, the duration of the reservation period) if the transmitter does not detect (or is unable to detect) the collisions.

As an example, vehicle-to-everything (V2X) communications, e.g., as specified by 3GPP TS 22.185 V.14.3.0, allows for communication between a vehicle (e.g., a mobile unit within a vehicle, such as a wireless device comprised within or currently contained within a vehicle and/or another transmitter contained or comprised with a vehicle) and various wireless devices. For example, as illustrated by FIG. 5, a vehicle, such as vehicle 502a, may communicate with various devices (e.g., devices 502b-f), such as road side units (RSUs), infrastnicture (V2I), network (V2N), pedestrian (V2P), and/or other vehicles (V2V). In addition, as shown, various devices within the V2X framework may communicate with other devices. V2X communications may utilize both long range (e.g., cellular) communications as well as short to medium range communications (e.g., non-cellular). In some contemplated implementations, the non-cellular communications may use unlicensed bands as well as a dedicated spectrum at 5.9 GHz. Moreover, V2X communications may include uni-cast, multi-cast, groupcast, and/or broadcast communications. Each communication type may employ an LBT mechanism.

As described above, under the V2X communication protocol a transmitter may reserve periodic slots within a reservation period. More specifically, in order to help prevent collisions on the shared sidelink channel, the various UEs in a network (e.g., a V2X network) may perform sidelink resource management for both network assisted resource management and autonomous (e.g., non-network assisted) resource management. In other words, the various UE devices may operate to determine or schedule the use of sidelink resources for transmissions to other UEs. In some embodiments, a UE. such as UE 106, may originate a semi-persistent sidelink schedule for a resource. A UE may broadcast a resource occupancy message (RO message) periodically. The RO message may include resource blocks (RBs) and/or sub-frames to be used (scheduled), a periodicity of resource occupancy (e.g., reservation), and/or, a time remaining for the resource occupancy (e.g., reservation). In addition, in some embodiments, a maximum allowed channel occupancy time (T_max_COT) may be defined. In such embodiments, an initial remaining time of the resource occupancy may not exceed the maximum allowed channel occupancy time. In other words, the resource occupancy may only be for a time less than the maximum allowed channel occupancy time.

In some embodiments, when a UE enters a new system (e.g., a new set of UEs and/or a new location), the UE may sense (listen) to a channel to collect existing UEs RO messages to determine available resources in the new system. In other words, prior to transmitting a RO message when entering a new set of UEs/area (e.g., a set of UEs with proximity for sidelink communications), the UE may determine available resources via reception of RO messages from neighboring UEs. In some embodiments, upon expiration of a resource occupancy, a UE, prior to transmitting a new RO message, may determine available resources via reception of RO messages from neighboring UEs.

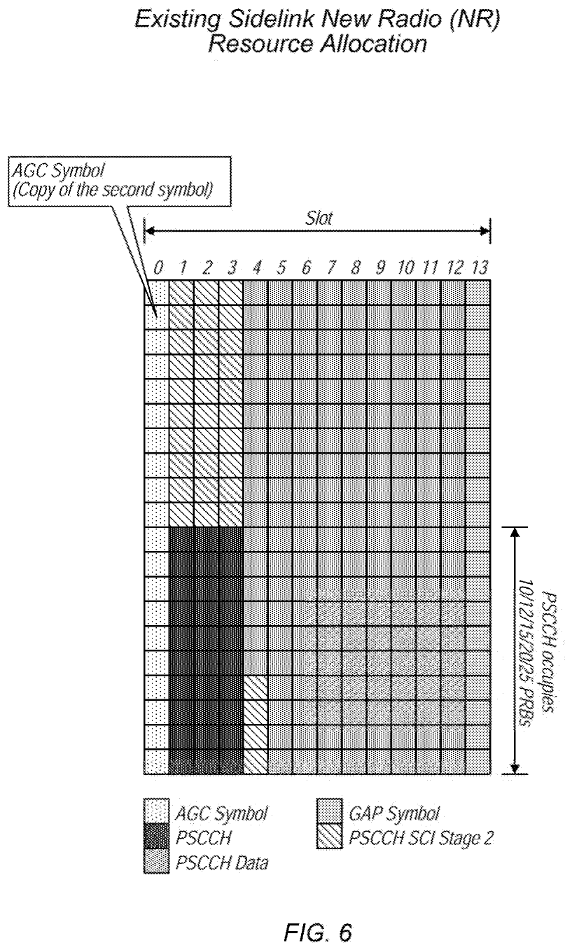

### FIG. 6 —Sidelink New Radio (NR) Data Channel

FIG. 6 illustrates an example sidelink channel, such as an NR sidelink data channel. The NR Physical Sidelink Shared Channel (PSSCH) may have a time domain with a maximum of 13 symbols. (Although a slot contains 14 symbols, one symbol may be used for a gap). The frequency domain may comprise a number of sub-channels, and each sub-channel may contain 10, 15, 20, 25, 50, 75 or 100 contiguous Physical Resource Blocks (PRBs). The starting sub-channel may be aligned with the Physical Sidelink Control Channel (PSCCH).

The NR sidelink PSSCH may contain both data and Sidelink Control Information (SCI) stage 2. These may comprise a HARQ process ID, a new data indicator (1 bit), a redundancy version (2 bits), a source ID (8 bits), a destination ID (16 bits), a channel state information (CSI) request (1 bit) (SCI stage 2 format B), A Zone ID (12 bits) (SCI stage 2 format A) and a communication range requirement (4 bits) (SCI stage 2 format A).

The current NR sidelink design may have limited coverage, similar to the coverage of the Uu interface of ˜140 dB MCL. As a result, there are certain situations in which sidelink communication may be desirable that NR currently cannot support. For example, in certain cases requiring long distance communication of about 2 kilometers, where two UEs have a Non-Line of Sight (NLOS) channel, the coverage requirement may be up to 160 dB MCL. As a result, it would be desirable to expand current NR sidelink coverage in order to provide commercial use in this scenario.

Different frequency bands have different regulatory requirements, for example, FCC requirements (US), BEREC requirements (Europe) and TENAA requirements (China). In order to be widely deployed, sidelink communications should function well on a frequency band that is commonly available globally. It is also preferable that sidelink communications operate well for one or more license-exempt or license-free bands, due to cost considerations. An example of a suitable frequency band for sidelink communications is the 900MHz ISM band, which requires narrowband transmission.

As a result, systems and methods are described herein for improving NR sidelink coverage using narrowband transmission, up to 1 MHz, and in some cases, up to 250 kHz. In current implementations, an NR PRB is 180 kHz when NR sub-carrier spacing is 15 kHz. As a result, in order to keep within 250 kHz, it is desirable for the narrowband transmission of a PSSCH to be contained within 1 PRB. As illustrated by FIG. 6, the current NR design cannot satisfy this requirement because the PSSCH is configured within a subchannel, and the minimum bandwidth per subchannel is 10 PRB, which is 1.8 Mhz.

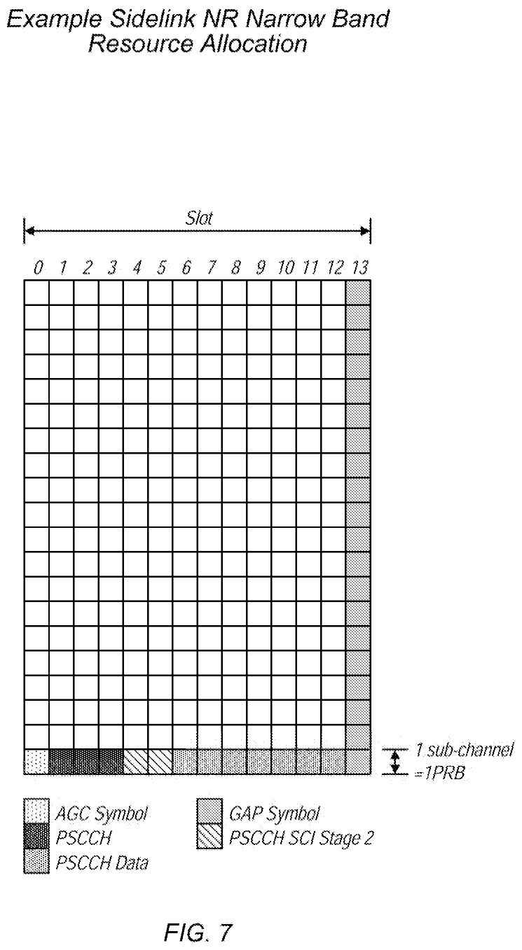

Therefore, to provide for the narrowband transmission of PSSCH, it may be desirable to reduce the size of a subchannel to contain 1 PRB. The use of 1 PRB per subchannel may also reduce UE complexity and power consumption. This design is illustrated by FIG. 7. In such embodiments, all of the information contained in the PSSCH may be transmitted within a single PRB.

Alternatively, an existing subchannel size may be maintained, and the UE may be allowed to use a fraction of the subchannel. In such embodiments, the UE may then only transmit on a subset of PRBs, for example, 1 PRB in the subchannel.

Embodiments may include narrowband transmission having sub-channel sizing corresponding to the narrowband bandwidth, for example, sub-channel sizing in the range of I—10 PRB, e.g., sub-channel sizing of 1 PRB, 3 PRB, 5 PRB, or 10 PRB.

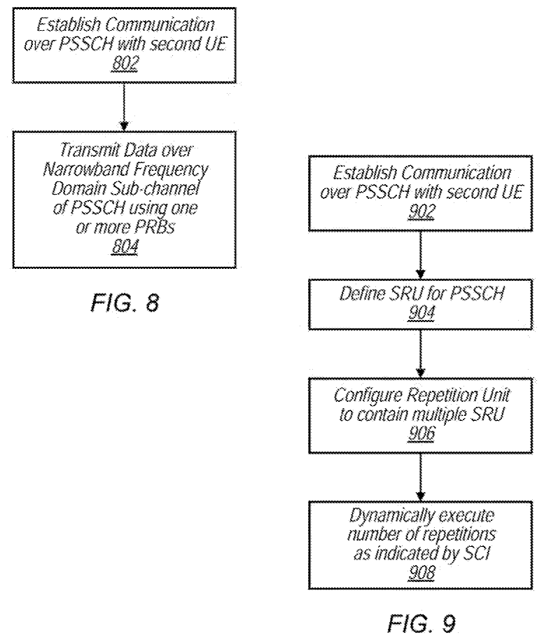

### FIG. 8—FlowChart for Enhanced Coverage NR Sidelink Narrow Band Transmission

FIG. 8 is a flowchart diagram illustrating an example method for a UE to perform enhanced coverage for sidelink narrowband transmission, according to some embodiments. Note that the method shown in FIG. 8 may be used in conjunction with any of the systems, methods, or devices shown in the Figures, among other devices. The described method steps may be performed by a UE communicating with another UE.

At 802, the UE establishes communication over a sidelink channel with a second UE, including the establishment of a physical sidelink shared channel (PSSCH) with the second UE.

At 804, the UE transmits data over a narrowband frequency domain sub-channel of the PSSCH to the second UE using one or more physical resource blocks (PRBs). In some embodiments, the UE transmits data using narrowband transmission, for example, up to 1 MHz, and in some embodiments, for example, up to 250 kHz. In order to keep within 250 kHz, the size of a subchannel may be reduced to contain 1 PRB. In some embodiments, all of the information contained in the PSSCH may be transmitted within a single PRB.

In some embodiments, an existing subchannel size may be maintained, and the UE may use a fraction of the subchannel. For example, the UE may only transmit on a subset of PRBs, for example, one PRB in a subchannel.

Embodiments may include narrowband transmission having sub-channel sizing corresponding to the narrowband bandwidth, for example, sub-channel sizing in the range of 1-10 PRB, e.g., sub-channel sizing of 1 PRB, 3 PRB, 5 PRB, or 10 PRB.

### FIG. 9—Flowchart for PSSCH Repetition

FIG. 9 is a flowchart diagram illustrating an example method for a UE to perform PSSCH transmission repetition. Note that the method shown in FIG. 9 may be used in conjunction with any of the systems, methods, or devices shown in the Figures, among other devices. The described method steps may be performed by a UE communicating with another UE.

At 902, the UE may establish communication with a second UE.

At 904, the UE may define a super resource unit (SRU) for PSSCH. Each SRU may contain multiple symbols or slots. In some embodiments, the length of the SRU may be hardcoded per a specification, and the length of the SRU may be based on sub-carrier spacing (SCS), for example. In some embodiments, the UE may configure the length of the SRU via radio resource control (RRC) or medium access control-control element (MAC-CE). In some embodiments, the UE and the second UE may cooperate to configure the length of the SRU.

At 906, the UE may configure a repetition unit to contain multiple SRUs. In some embodiments, the UE may configure the number of SRUs in each repetition via RRC or MAC-CE. For example, when the UE is performing a radio resource connection (RRC) with a second UE, the two UEs may configure the number of SRUs in each repetition unit at that time. Alternatively, or in addition, the two UEs may configure, or adjust, the number of SRUs in each repetition unit later using a MAC control element

At 908, the UE may dynamically indicate the number of repetitions via sidelink control information (SCI). In some embodiments, the UE may configure resource allocations differently for each resource pool. For example, the UE may configure the number of RUs per SRU and/or the number of SRUs per repetition differently for each resource pool.

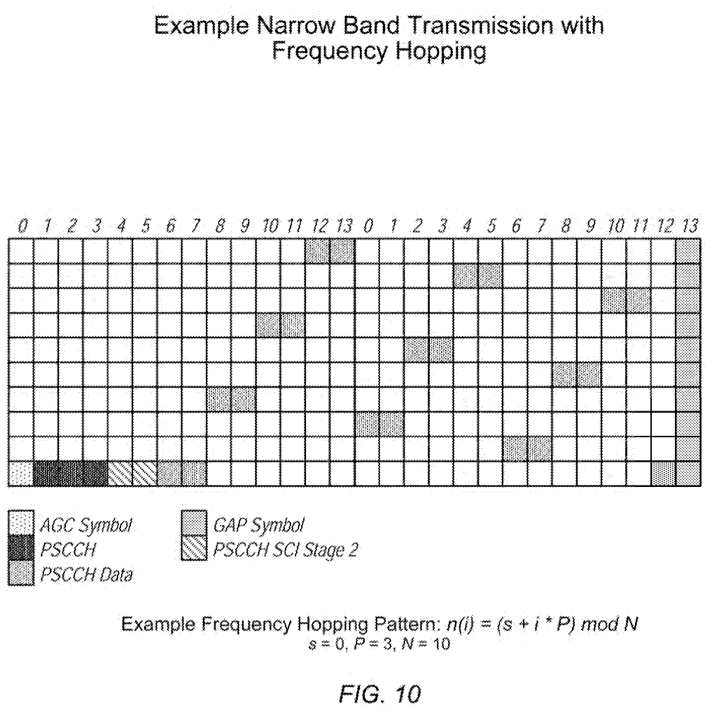

FIG. 10 illustrates an embodiment of narrowband transmission with frequency hopping. Frequency hopping may provide coverage enhancement. In some embodiments, a frequency hopping pattern may be hard-coded in a UE. In some embodiments where a UE is within network coverage, a frequency hopping pattern may be configured for the UE by the cellular network (e.g., the base station). In some embodiments, the UE may configure its own frequency hopping pattern and may notify other UEs accordingly.

With reference to FIG. 10, the frequency domain resource granularity may be a number of PRBs or a number of sub-channels. The time domain resource granularity may be a number of symbols or a number of slots. The hopping pattern may follow a certain equation such as

n(i)=(s+i×P) mod N,

where n(i) is the frequency location of the (i+1)th hopping, s is the starting frequency unit, P is the hopping distance and N is the total number of frequency resource units.

The example of FIG. 10 illustrates the hopping pattern described by the equation above when s=0, P=3 and N=10.

A UE may communicate contemporaneously with more than one other UE. A pair of UEs that are in communication with one another are known as a device pair (or as a UE pair). Each device pair may use a different sidelink resource pool in communicating with one another. A frequency hopping pattern may be configured differently for each sidelink resource pool. For example, when a UE is communicating with a device that is far away, a substantial frequency hopping pattern may be desirable to maximize coverage. However, when a UE is communicating with a device that is nearby, maximum coverage is unnecessary. Therefore, minimal or no frequency hopping may be desirable in order to minimize power consumption. Frequency hopping may also be designed to allow a resource unit to cross a resource pool boundary.

A UE may perform resource sensing to determine which resource grid may be used to carry out a frequency hopping pattern. However, after the sensing, it may be difficult for a UE to guarantee that all of the resource units (RUs) are available at any given time, as some of the RUs may become occupied by other device pairs. As a result, a frequency hopping pattern may collide with one or more RUs that are being employed by other UEs. A UE may handle this situation in a number of ways. For example, in some embodiments, when the frequency hopping pattern collides with an unavailable RU, the UE may omit or shift the corresponding hopping occasion to the next available RU. As another example, in some embodiments, the UE may index in increasing order all of the RUs that are selected based on resource sensing, for example, frequency domain first and time domain second. The frequency hopping may then be performed based at least in part on the index of the selected RUs. In some embodiments when narrowband frequency hopping is adopted, a UE may be given priority such that it will not have to yield RUs to another UE. In this case, the UE may not need to perform sensing, or the UE may only need to perform partial sensing or random selection, and no action may need be taken when a possible collision is detected.

### Support for PSSCH Repetition

Embodiments described herein provide for support for flexible PSSCH repetition in order to improve network coverage. Repetition may be used for coverage enhancement as it allows more energy to be accumulated and for higher reliability to be achieved. In order to provide this support, the UE may configure a Super Resource Unit (SRU) as an alternative scheduling unit to a slot or to an RU. Each SRU may contain multiple symbols or slots.

In some embodiments, the length of the SRU may be hardcoded per a specification, and may be based on Subcarrier Spacing (SCS), for example. Alternatively, in some embodiments, the length of the SRU may be configurable via Radio Resource Control (RRC) or Medium Access Control—Control Element (MAC-CE). In other words, the UE may exchange information with another UE (or the base station) during RRC to configure the length of the SRU. Alternatively, or in addition, a first UE may transmit information to a second UE configuring the length of the SRU, e.g., further adjusting a length previously set during RRC. In addition to the configuration of an SRU, the UE may configure a basic repetition unit. Each repetition unit may contain multiple SRUs. The number of SRUs in each repetition may be configured via RRC or MAC-CE as mentioned above. As with the configuration of the SRU, the RRC may be used to configure a coarse unit of repetition and the MAC-CE may be used to fine-tune the size of the repetition unit. In some embodiments, the number of repetitions may be dynamically indicated by SCI.

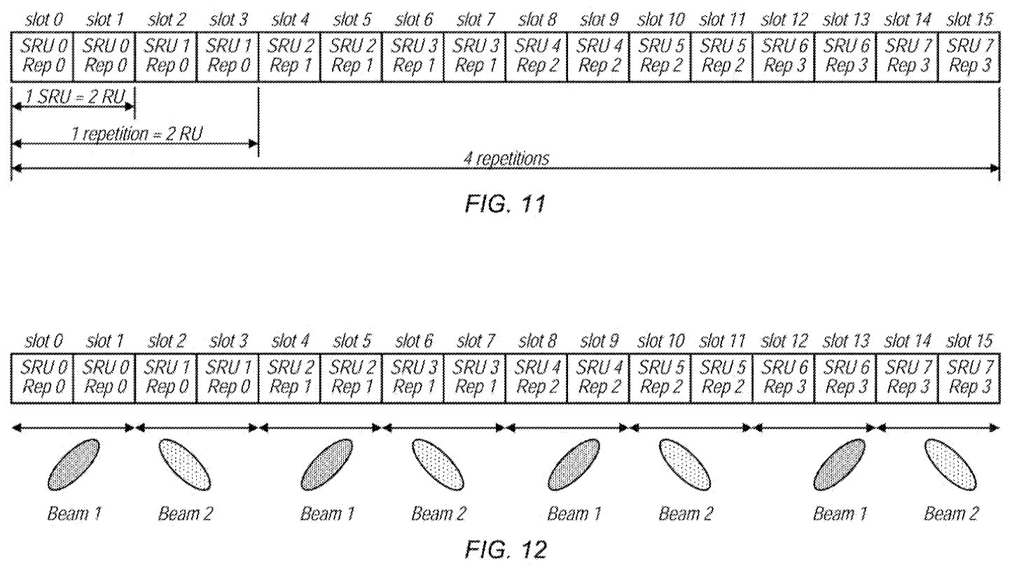

FIG. 11 shows an example resource allocation, according to some embodiments, having four repetitions wherein l RU=1 slot, l SRU=2 RU=2 slots, and l repetition unit=2 SRU=4 RU=4 slots. In this example, the total repetition will span 16 slots, which may provide 16 times better coverage and an approximate enhancement of 12 dB over the current PSSCH design.

As previously described, in some embodiments, a UE may communicate contemporaneously with more than one other UE and may use different resource pools for each separate communication. In some embodiments, the UE may configure resource allocation differently for each resource pool. For example, the number of RUs per SRU and/or the number of SRUs per repetition may vary by resource pool.

In some embodiments that comprise a beam-based system, for example, Frequency Range 2 (FR2), the UE may utilize multiple beams to increase the reliability of transmission. Beam cycling may be combined with PSSCH repetition. For example, a UE may allocate different beams to different RUs and/or different SRUs and/or different repetition units, and may “sweep” across multiple RUs, SRUs and/or repetition units. Use of multiple beams may further increase reliability through providing alternative signaling in case one or more beams are blocked, for example, by a user's head or hand.

FIG. 12 shows an example involving two beams, beam 1 and beam 2. Each beam sweeps over 2 slots at a frequency of every 2 SRU.

In some embodiments, after a basic repetition unit is defined, the Transport Block (TB) may be defined. In some embodiments, a UE may make a TB size determination based solely on the size of the first RU. In some embodiments, the UE may make a TB size determination based solely on the size of the first SRU. In some embodiments, the TB size determination may be based solely on the size of the first repetition unit. In some embodiments, the UE may make a TB size determination based on the size of all of the repetition units.

In determining the size of the TB, there may be a trade-off between the data rate of a transmission and the reliability of the transmission. When the TB size is small, the data rate may be small but the reliability may be high. Conversely, when the TB size is large, the data rate may be large but the reliability may be small.

In some embodiments, a UE may configure different Redundancy Versions (RVs) for each RU. The UE may configure different RVs for each SRU, and may be based on the size of the RU, the size of the SRU or the size of the repetition unit.

### Advanced PSSCH Repetition

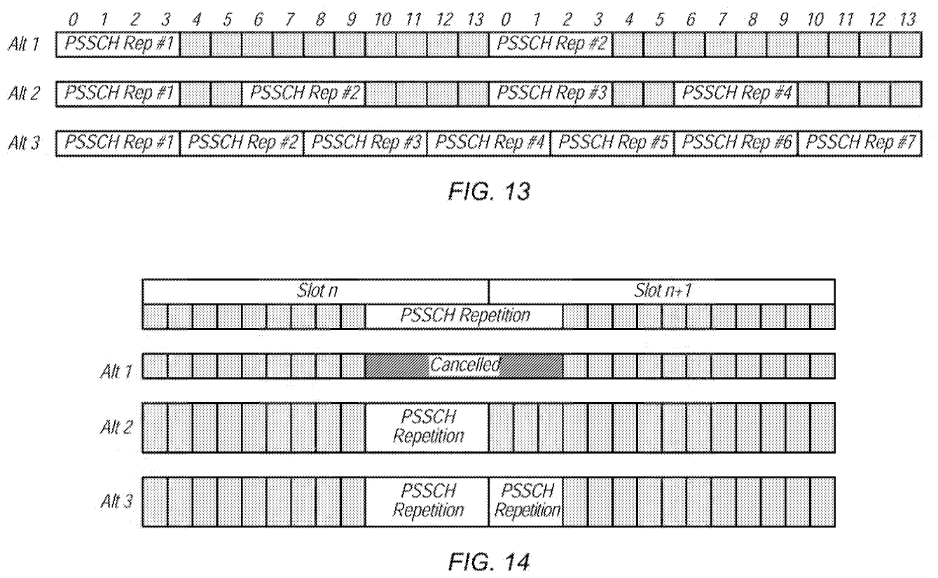

FIG. 13 illustrates three alternate embodiments of advanced PSSCH repetition. Alternate 1 shows an example of intra-slot repetition. In some embodiments, within a slot, a UE may configure a PSSCH repetition and the UE may then determine for how many slots this configuration will be repeated. In some embodiments, the PSSCH may be repeated in the same location of each slot.

Alternative 2 is a combination of intra-slot repetition and inter-slot repetition to increase the number of repetitions over Alternative 1. Within each slot, a UE may configure a fixed number of repetitions and a fixed offset. In this example, the PSSCH configuration is repeated twice with a two-symbol offset. As in Alternative 1, the UE determines for how many slots this configuration will be repeated, and the configurations may be repeated at the same locations in each slot.

Alternative 3 shows a pattern having a very dense repetition resulting in a possibility that a repetition may cross a slot boundary. Such an alternative may have a fixed offset, although the example shown in FIG. 13 shows no offset.

FIG. 14 illustrates three example alternative methods for addressing an interruption of a repetition occasion, according to some embodiments. Such an interruption may result, for example, from a repetition occasion crossing a slot boundary, as shown, for example, by Alternative 3 of FIG. 13.

In a first example, (Alt 1), a UE handles an interruption by omitting the transmission of the entire repetition occasion. In a second example, (Alt 2), the UE truncates the repetition occasion at the first collision. In a third example, (Alt 3), the UE segments the repetition into multiple actual repetitions.

In embodiments involving precoding and/or beam diversity, a UE may configure resource bundling in both the frequency domain and in the time domain. In some embodiments, in the frequency domain, the UE may bundle resources in the units of multiple PRB/sub-channels and may change the beam for each resource bundle. In some embodiments, in the time domain, the UE may bundle resources in the units of multiple symbols/slots, and again, may change the beam for each resource bundle. In some embodiments, within the same frequency and/or time domain bundle, the Demodulation Reference Signal (DMRS) and the PSSCH are assumed to be Quasi-Co-located (QCLed) in terms of their channel properties.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A user equipment (UE), comprising:
at least one antenna;
a radio operably coupled to the at least one antenna; and
a processor operably coupled to the radio;
wherein the UE is configured to:
establish communication over a sidelink channel with a second UE, including establishment of a physical sidelink shared channel (PSSCH) with the second UE;
transmit data over the PSSCH to the second UE, wherein the data is transmitted over a narrowband frequency domain sub-channel of the PSSCH using one or more physical resource blocks (PRBs), wherein a number of the PRBs corresponds to the narrowband bandwidth.

2. The UE of claim 1,
wherein the narrowband frequency domain sub-channel of the PSSCH comprises one physical resource block (PRB).

3. The UE of claim 1,
wherein the PSSCH comprises a plurality of subchannels, wherein each subchannel comprises a plurality of physical resource blocks;
wherein when transmitting over a subchannel comprising a plurality of physical resource blocks, the UE is configured to transmit on a narrowband subset of the plurality of physical resource blocks.

4. The UE of claim 3,
wherein the narrowband subset of the plurality of physical resource blocks comprises one physical resource block.

5. The UE of claim 1, wherein the UE is further configured to:
transmit the data over a plurality of frequency domain sub-channels of the PSSCH using frequency hopping.

6. The UE of claim 5, wherein the UE is further configured to:
define a resource unit as one or more of a number of PRBs or a number of sub-channels in a frequency domain and a number of symbols in a time domain;
define a frequency hopping pattern over the PSSCH as comprising a plurality of predetermined resource units, wherein each of the predetermined resource units is located at one or more of a different time or a different frequency; and
transmit the data using the predetermined resource units in accordance with the frequency hopping pattern.

7. The UE of claim 6, wherein the frequency hopping pattern is defined by
n(i)=(s+i×P) mod N,
where n(i) is a frequency location of the (i+1)th hopping, s is a starting frequency unit, P is a hopping distance and N is a total number of resource units.

8. The UE of claim 6, wherein the UE is further configured to:
determine that a first resource unit of the plurality of predetermined resource units is unavailable; and
in response to determining that the first resource unit is unavailable, omit a hopping occasion corresponding to the first resource unit.

9. The UE of claim 6, wherein the UE is further configured to:
determine that a first resource unit of the plurality of predetermined resource units is unavailable; and
in response to determining that the first resource unit is unavailable. shift a hopping occasion corresponding to the first resource unit to a next available resource unit.

10. The UE of claim 5, wherein the UE is further configured to:
define a resource unit as one or more of a number of PRBs or a number of sub-channels in a frequency domain and a number of symbols in a time domain;
identify a set of available predetermined resource units;
index the set of available predetermined resource units;
define a frequency hopping pattern over the PSSCH as comprising a plurality of available predetermined resource units, wherein each of the available predetermined resource units is located at one or more of a different time or a different frequency; and
transmit the data using the indexed set of available predetermined resource units in accordance with the frequency hopping pattern.

11. The UE of claim 6, wherein the predetermined resource units are selected from a resource pool, wherein the UE has priority use for each of the resource units in the resource pool.

12. The UE of claim 1,
wherein the transmitted data comprises a plurality of resource units;
wherein the UE is configured to transmit the plurality of resource units for a plurality of repetitions for improved cellular coverage.

13. The UE of claim 12.
wherein the UE is configured to define a super resource unit comprising plurality of resource units;
wherein the UE is configured to transmit the super resource unit for a plurality of repetitions for improved cellular coverage.

14. The UE of claim 13,
wherein the UE is configured to specify a length of the super resource unit using at least one of radio resource connection (RRC) configuration; a medium access control control element (MAC-CE); or sidelink control information (SCI).

15. The UE of claim 13,
wherein the UE is configured to specify a first length of the super resource unit using a radio resource connection (RRC) configuration;
wherein the UE is further configured to adjust the first length of the super resource unit using at least one of a medium access control-control element (MAC-CE) or sidelink control information (SCI).

16. The UE of claim 13,
wherein the UE is configured to specify a number of the repetitions using sidelink control information.

17. A baseband processor configured for use in a user equipment (UE), comprising:
processing circuitry configured to:
establish communication over a sidelink channel with a second UE, including establishment of a physical sidelink shared channel (PSSCH) with the second UE;
transmit data over the PSSCH to the second UE, wherein the data is transmitted over a narrowband frequency domain sub-channel of the PSSCH using one or more physical resource blocks (PRBs), wherein a number of the PRBs corresponds to the narrowband bandwidth.

18. The baseband processor of claim 17,
wherein the PSSCH comprises a plurality of subchannels, wherein each subchannel comprises a plurality of physical resource blocks;
wherein when transmitting over a subchannel comprising a plurality of physical resource blocks, the UE is configured to transmit on a narrowband subset of the plurality of physical resource blocks.

19. The baseband processor of claim 17, wherein the baseband processor is Further configured to:
transmit the data over a plurality of frequency domain sub-channels of the PSSCH using frequency hopping.

20. The baseband processor of claim 17, wherein the baseband processor is further configured to:
define a resource unit as one or more of a number of PRBs or a number of sub-channels in a frequency domain and a number of symbols in a time domain:
define a frequency hopping pattern over the PSSCH as comprising a plurality of predetermined resource units, wherein each of the predetermined resource units is located at one or more of a different time or a different frequency: and
transmit the data using the predetermined resource units in accordance with the frequency hopping pattern.

21. A user equipment (UE), comprising:
at least one antenna;
a radio operably coupled to the at least one antenna; and
a processor operably coupled to the radio;
wherein the UE is configured to:
establish communication over a sidelink channel with a second UE, including establishment of a physical sidelink shared channel (PSSCH) with the second UE;
transmit data over the PSSCH to the second UE, wherein the transmitted data comprises the data and a plurality of repetition units of the data, wherein each of the repetition units comprises a plurality of resource units, and wherein the plurality of repetition units are transmitted for improved cellular coverage.

22. The UE of claim 21,
wherein the UE is configured to define a super resource unit comprising plurality of resource units;
wherein each of the repetition units comprises a plurality of super resource units.

23. The UE of claim 22,
wherein the UE is configured to specify a different length of the super resource unit for each of a plurality of different UE pairs.

24. The UE of claim 22,
wherein the UE is configured to specify a length of the super resource unit using at least one of radio resource connection (RRC) configuration; a medium access control control element (MAC-CE); or sidelink control information (SC1).

25. The UE of claim 22,
wherein the UE is configured to specify a first length of the super resource unit using a radio resource connection (RRC) configuration;
wherein the UE is further configured to adjust the first length of the super resource unit using at least one of a medium access control control element (MAC-CE) or sidelink control information (SCI).

26. The UE of claim 21,
wherein the UE is configured to specify a number of the repetitions using sidelink control information.

27. The UE of claim 21, wherein each of the one or more antennas transmits using a beam, and wherein the UE is further configured to:
allocate each beam to one or more resource units or one or more super resource units.

28. The UE of claim 21, wherein each of the one or more antennas transmits using a beam, and wherein UE is further configured to:
allocate each beam to one or more sub-channels or one or more physical resource blocks.

29. The UE of claim 21, wherein each of the one or more antennas transmits using a beam, and wherein UE is further configured to
allocate each beam to a different repetition unit.

30. The UE of claim 21, wherein the UE is further configured to:
determine transport block (TB) allocation based on one or more of: 1) a first resource unit of the plurality of resource units; 2) a first super resource unit of a plurality of transmitted super resource units; or 3) a first repetition of a plurality of repetitions of transmitted data.

31. The UE of claim 21,
wherein the plurality of repetition units are configured for transmission at a plurality of repetition occasions according to a repetition pattern, wherein at least one of the repetition occasions crosses a slot boundary;
wherein the UE is configured to:
detect that a first repetition occasion crosses a slot boundary;
omit the first repetition occasion from the repetition pattern.

32. The UE of claim 21,
wherein the plurality of repetition units are configured for transmission at a plurality of repetition occasions according to a repetition pattern, wherein at least one of the repetition occasions crosses a slot boundary;
wherein the UE is configured to:
detect that a first repetition occasion crosses a slot boundary;
truncate the first repetition occasion at the slot boundary.

33. The UE of claim 21,
wherein the plurality of repetition units are configured for transmission at a plurality of repetition occasions according to a repetition pattern, wherein at least one of the repetition occasions crosses a slot boundary;
wherein the UE is configured to:
detect that a first repetition occasion crosses a slot boundary;
segment the first repetition occasion into two repetition occasion segments, wherein a first repetition occasion segments ends at the slot boundary and a second repetition occasion segments begins following the slot boundary.
